(19) United States
(12) Patent Application Publication
(10) Pub. No.: US 2004/0161289 A1
(43) Pub. Date: Aug. 19, 2004

(54) Novelty flexible topper device

(76) Inventor: Barry Silberman, Boca Raton, FL (US)

Correspondence Address: RUDEN, MCCLOSKY, SMITH, SCHUSTER & RUSSELL, P.A., P.O. BOX 1900, FORT LAUDERDALE, FL, 33301, US

(21) Appl. No.: 10/780,834

(22) Filed: Feb. 18, 2004

Related U.S. Application Data
(60) Provisional application No. 60/448,254, filed on Feb. 19, 2003.

(51) Int. Cl. B43K 29/00; A63H 33/00

(52) U.S. Cl. 401/195

(57) ABSTRACT

A novelty flexible topper is disclosed including a flexible housing forming a chamber for containing a novelty toy, and a topper securement operatively engaged to the flexible housing. The present invention is further directed to combination writing device and novelty flexible topper comprising a cylindrical body having a longitudinal bore and an end region, a writing member including a tip and a writing supply incorporated in the longitudinal bore, a flexible housing forming a chamber for containing a novelty toy, the flexible housing operatively engaged to a topper securement, the topper securement positioned on the end region, and wherein the chamber is fluid-filled.

### CROSS-REFERENCE TO RELATED APPLICATIONS

This application claims the benefit of U.S. Provisional Application Serial No. 60/448,254, filed on Feb. 19, 2003, entitled NOVELTY FLEXIBLE TOPPER DEVICE.

### TECHNICAL FIELD

The present invention relates generally to writing apparatuses. More specifically, the present invention relates to a combination pen and novelty flexible topper arrangement in which a flexible topper is integrated with an end of the cylindrical body of a pen and contains a chamber to hold a novelty toy.

### BACKGROUND OF THE INVENTION

Heretofore various devices have been made which include elongated, flexible, bendable hollow tube-like components. Some of these have been set forth in U.S. patents. U.S. Pat. No. 3,134,453 sets forth an amusement device having an elongated part made of spring steel sheathed by a protective covering. The elongated part can be bent into different shapes. U.S. Pat. No. 4,034,499 has an elongated hollow bendable tubular member that is used in a musical device for making different sounds. U.S. Pat. No. 4,495,550 sets forth a flashlight with a flexible bellows that can be bent in different directions for directing the light to different places. U.S. Pat. No. 4,579,538 is directed to a construction toy that utilizes bendable hollow members. U.S. Pat. No. 3,615,596 sets forth a combination lollipop-writing accessory with a rigid body portion.

Other prior art novelty devices for attachment to writing utensils include devices such as U.S. Pat. No. 6,056,464 for a novelty attachment for a pencil or pen that includes a hollow shell with sounding beads which, when attached to a pen or pencil, can act as a maraca or rattle.

However, the prior art lacks a novelty device for attachment to writing utensils that is resiliently flexible and houses a novelty toy or game that is viewed through the resiliently flexible housing.

### SUMMARY OF THE INVENTION

The present invention eliminates the above-mentioned needs by providing a combination writing device and novelty flexible topper that permits viewing of a novelty item contained therein.

In accordance with the present invention, there is provided a novelty flexible topper comprising a flexible housing forming a chamber for containing a novelty toy, and a topper securement operatively engaged to the flexible housing.

The present invention is further directed to combination writing device and novelty flexible topper comprising a cylindrical body having a longitudinal bore and an end region, a writing member including a tip and a writing supply incorporated in the longitudinal bore, a flexible housing forming a chamber for containing a novelty toy, the flexible housing operatively engaged to a topper securement, the topper securement positioned on the end region, and wherein the chamber is fluid-filled.

The present invention is still further directed to novelty flexible topper comprising a flexible housing forming a chamber for containing a novelty toy, and a connector for engaging a dispensing device, the connector attaching to the flexible housing and sealing the chamber.

### BRIEF DESCRIPTION OF THE FIGURES

FIG. 1 is a front view illustration of the preferred embodiment of the present invention.

FIG. 2 is a front view illustration of an alternative embodiment of the present invention.

FIG. 3 is a bottom view illustration of the preferred embodiment of the present invention of FIG. 1.

### DETAILED DESCRIPTION OF THE INVENTION

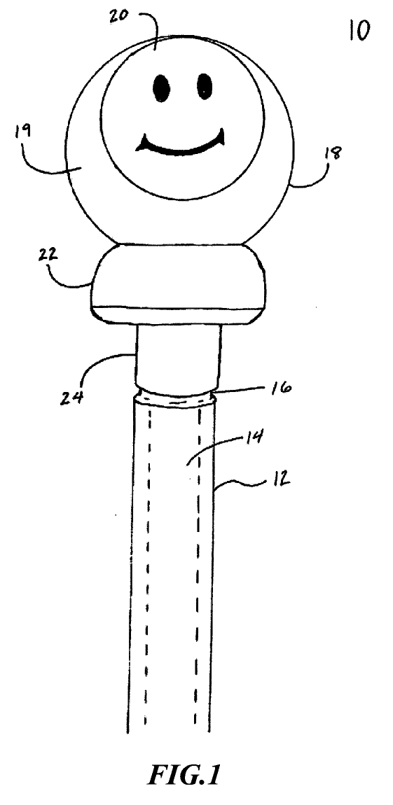

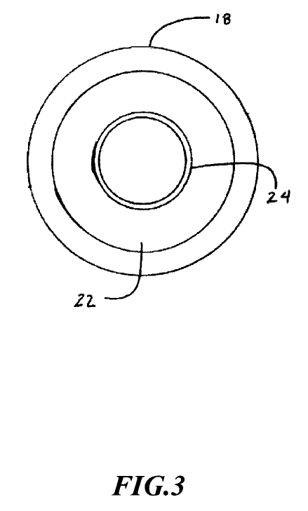

Referring now to FIGS. 1 and 3, a preferred embodiment of the present invention is illustrated as novelty flexible topper 10. Novelty flexible topper 10 includes a cylindrical body 12 having a longitudinal bore 14 and an end region 16, a writing member (not shown) including a tip and a writing supply, and a flexible housing 18 forming a chamber 19 for containing a novelty toy 20 securely positioned to end region 16. Additionally, novelty flexible topper 10 may be used to play games or otherwise entertain a user.

Cylindrical body 12 houses a writing supply within longitudinal bore 14 and terminates at a tip end. The writing supply includes a writing material. The writing material can be any material used to create handwriting, including, but not limited to, carbon, graphite, various inks, dyes, and the like. The tip permits the writing material to contact a writing surface, such as paper. As such, cylindrical body 12 functions as a dispenser, and can dispense various materials other than writing materials, including, but not limited to bubble-forming materials (such as soaps), candies, beads, and toys.

Cylindrical body 12 also includes end region 16. End region 16 accommodates topper securement 24, thereby permitting novelty flexible topper 10 releasable attachment to cylindrical body 12. Topper securement 24 is internally sized to receive the end of a pen or pencil. In one arrangement, internal protrusions, such as ridges (not shown) are provided to grip the end of a pen or pencil. Topper securement 24 is integrally connected to flexible housing base 22 so as to allow an association between flexible housing 18 and cylindrical body 12, forming a connector. A unitary construction forming topper securement 24 and flexible housing base 22 as a single connector is also contemplated. Flexible housing base 22 fastens to flexible housing 18, thereby forming an internal chamber 19 for containing novelty toy 20.

While cylindrical body 12 has been described as “cylindrical”, this term is used in a broad sense to include arrangements that may not be circular in cross-section. For example, cylindrical body 12 may be hexagonal in cross-section to receive a hexagonal cross-section pen or pencil. It is also possible to use a non-circular cross-section with a circular pen or pencil or to use a circular cross-section with a non-circular pen or pencil.

Flexible housing 18 is formed from any one of a number of materials that have elastic properties and permit the passage of at least some light therethrough. Such materials include, but are not limited to rubbers, plastics, polymers, and the like.

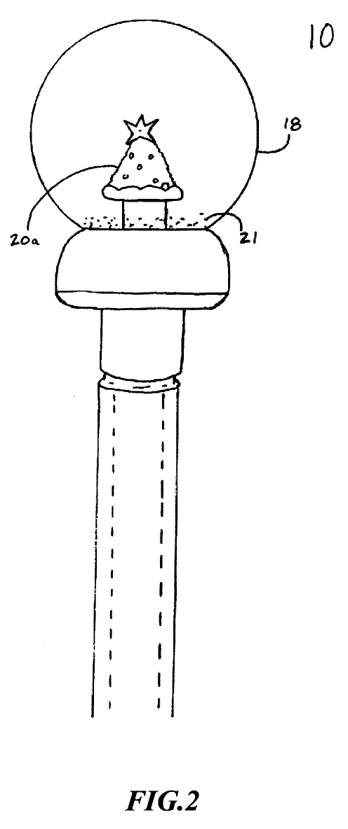

Fastening flexible housing base 22 to flexible housing 18 forms chamber 19, which is used to house novelty toy 20. Chamber 19 may be fluid-filled to allow buoyant novelty items to float within chamber 19. Additionally, as shown in FIG. 2, novelty toy may include a snow globe-like toy 20a. Further novelty items may be incorporated, such as games or colored water and oil mixtures and the like. It will also be recognized that a wide variety of novelty shapes can be used for flexible housing 18 to provide a variety of items as well, such as children's souvenirs depicting clowns, animals, cartoon characters, fictitious characters, vehicles and the like.

Although only a few exemplary embodiments of the present invention have been described in detail above, those skilled in the art will readily appreciate that numerous modifications are to the exemplary embodiments are possible without materially departing from the novel teachings and advantages of this invention. Accordingly, all such modifications are intended to be included within the scope of this invention as defined in the following claims.

What is claimed is:

1. A novelty flexible topper, comprising:
a flexible housing forming a chamber for containing a novelty toy; and
a topper securement operatively engaged to said flexible housing.

2. The flexible topper according to claim 1 wherein said topper securement is positioned on an end region of a cylindrical body having a longitudinal bore.

3. The flexible topper according to claim 1 wherein said chamber is fluid-filled.

4. The flexible topper according to claim 1 wherein said topper securement is positioned on a bubble dispenser.

5. A combination writing device and novelty flexible topper, comprising:
a cylindrical body having a longitudinal bore and an end region;
a writing member including a tip and a writing supply incorporated in said longitudinal bore;
a flexible housing forming a chamber for containing a novelty toy, said flexible housing operatively engaged to a topper securement, said topper securement positioned on said end region; and
wherein said chamber is fluid-filled.

6. A novelty flexible topper, comprising:
a flexible housing forming a chamber for containing a novelty toy; and
a connector for engaging a dispensing device, said connector attaching to said flexible housing and sealing said chamber.

7. The flexible topper according to claim 6 wherein said chamber is fluid-filled.
